(19) United States
(12) Patent Application Publication
(10) Pub. No.: US 2022/0261627 A1
(43) Pub. Date: Aug. 18, 2022

(54) DRIVING MONITORING AND SCORING SYSTEMS AND METHODS

(71) Applicant: GM GLOBAL TECHNOLOGY OPERATIONS LLC, Detroit, MI (US)

(72) Inventors: Ramesh Sethu, Troy, MI (US); Prakash Mohan Peranandam, Rochester Hills, MI (US); Rami I. Debouk, Dearborn, MI (US); Arun Adiththan, Warren, MI (US); Guangyu J. Zou, Warren, MI (US)

(73) Assignee: GM GLOBAL TECHNOLOGY OPERATIONS LLC, Detroit, MI (US)

(21) Appl. No.: 17/174,750

(22) Filed: Feb. 12, 2021

(51) Int. Cl. G06N 3/08; G06N 3/04; G07C 5/04

(52) U.S. Cl. CPC G06N 3/08; G07C 5/04; G06N 3/04

(57) ABSTRACT

Systems and method are provided for monitoring an operator of a vehicle. In one embodiment, a method includes: receiving, by a processor, data generated by the vehicle; determining, by the processor, causal time series event data based on the received data; computing, by the processor, a score for at least one of safety and quality based on a first machine learning model and the causal time series event data; computing, by the processor, at least one explanation for the score based on a second machine learning model; and generating, by the processor, display data to display at least one of the causal time series event data, the score, and the explanation to an end user.

### INTRODUCTION

The present disclosure generally relates to vehicles, and more particularly relates to systems and methods for continuously monitoring vehicle in motion and computing comprehensive scores associated with safety and driving quality.

An autonomous vehicle is a vehicle that is capable of sensing its environment and navigating with little or no user input. An autonomous vehicle senses its environment using sensing devices such as radar, lidar, image sensors such as cameras, and the like. The autonomous vehicle system further uses information from global positioning systems (GPS) technology, navigation systems, vehicle-to-vehicle communication, vehicle-to-infrastructure technology, and/or drive-by-wire systems to navigate the vehicle.

While recent years have seen significant advancements in autonomous vehicle systems, such systems might still be improved in a number of respects. For example, systems and methods that assess driving quality and or safety of the operation of the autonomous vehicle, either by a driver or the vehicle alone, rely on instantaneous and limited information collected from sensors and actuators (e.g., hard brake, sudden acceleration, etc.). This leads to poor and limited estimation of safety and driving quality.

Accordingly, it is desirable to provide systems and methods for continuously monitoring vehicle in motion and computing comprehensive scores associated with safety and driving quality. Furthermore, other desirable features and characteristics of the present disclosure will become apparent from the subsequent detailed description and the appended claims, taken in conjunction with the accompanying drawings and the foregoing technical field and background.

### SUMMARY

Systems and method are provided for monitoring an operator of a vehicle. In one embodiment, a method includes: receiving, by a processor, data generated by the vehicle; determining, by the processor, causal time series event data based on the received data; computing, by the processor, a score for at least one of safety and quality based on a first machine learning model and the causal time series event data; computing, by the processor, at least one explanation for the score based on a second machine learning model; and generating, by the processor, display data to display at least one of the causal time series event data, the score, and the explanation to an end user.

In various embodiments, the first machine model is a deep neural network. In various embodiments, the deep neural network is trained based on ground truth data and crowd sourced driving data.

In various embodiments, the first machine learning model is a gradient boosting machine. In various embodiments, the gradient boosting machine is trained based on ground truth data and crowd sourced driving data.

In various embodiments, the second machine learning model is a classification network that outputs probabilities of score classes and explanations.

In various embodiments, the second machine learning model is a structured causal model that outputs causal explanations.

In various embodiments, the received data comprises sensor data and message data, wherein the determining the causal time series event data comprises processing the sensor data and the message data over a time period to determine a context of a scenario associated with the time period, wherein the causal time series event data includes the context. In various embodiments, the received data comprises actuator data, wherein the determining the causal time series event data comprises processing the actuator data over the time period to determine behavior of actors in the scenario, and wherein the time series event data includes the behavior.

In various embodiments, the causal time series data includes a vector representation of the context concatenated with a vector representation of the behavior.

In another embodiments, system for monitoring an operator of a vehicle includes: a first non-transitory computer module that, by a processor, receives data generated by the vehicle, and determines causal time series event data based on the received data; a second non-transitory module that, by a processor, computes a score for at least one of safety and quality based on a first machine learning model and the causal time series event data; a third non-transitory module that, by a processor, computes at least one explanation for the score based on a second machine learning model; and a fourth non-transitory module that, by a processor, generates display data to display at least one of the causal time series event data, the score, and the explanation to an end user.

In various embodiments, the first machine model is a deep neural network. In various embodiments, the deep neural network is trained based on ground truth data and crowd sourced driving data.

In various embodiments, the first machine learning model is a gradient boosting machine. In various embodiments, the gradient boosting machine is trained based on ground truth data and crowd sourced driving data.

In various embodiments, the second machine learning model is a classification network that outputs probabilities of score classes and explanations.

In various embodiments, the second machine learning model is a structured causal model that outputs causal explanations.

In various embodiments, the received data comprises sensor data and message data, wherein the first non-transitory module determines the causal time series event data by processing the sensor data and the message data over a time period to determine a context of a scenario associated with the time period, wherein the causal time series event data includes the context.

In various embodiments, the received data comprises actuator data, wherein the first non-transitory module determines the causal time series event data by processing the actuator data over the time period to determine behavior of actors in the scenario, and wherein the time series event data includes the behavior.

In various embodiments, the causal time series data includes a vector representation of the context concatenated with a vector representation of the behavior.

### BRIEF DESCRIPTION OF THE DRAWINGS

The exemplary embodiments will hereinafter be described in conjunction with the following drawing figures, wherein like numerals denote like elements, and wherein:

FIG. 1 is a functional block diagram illustrating an autonomous vehicle having a quality and safety assessing system, in accordance with various embodiments;

FIG. 2 is a functional block diagram illustrating a transportation system having one or more autonomous vehicles of FIG. 1, in accordance with various embodiments;

FIG. 3 is a dataflow diagram illustrating an autonomous driving system that includes having a quality and safety assessing system of the autonomous vehicle, in accordance with various embodiments;

FIG. 4 is a dataflow diagram illustrating the quality and safety assessing system, in accordance with various embodiments;

FIG. 5 and is an illustration of time-series chain event data generated by the quality and safety assessing system, in accordance with various embodiments;

FIG. 6 is an illustration of score output produced by the quality and safety assessing system, in accordance with various embodiments; and

FIG. 7 is a flowchart illustrating a control method for monitoring and scoring quality and safety operations of the autonomous vehicle, in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

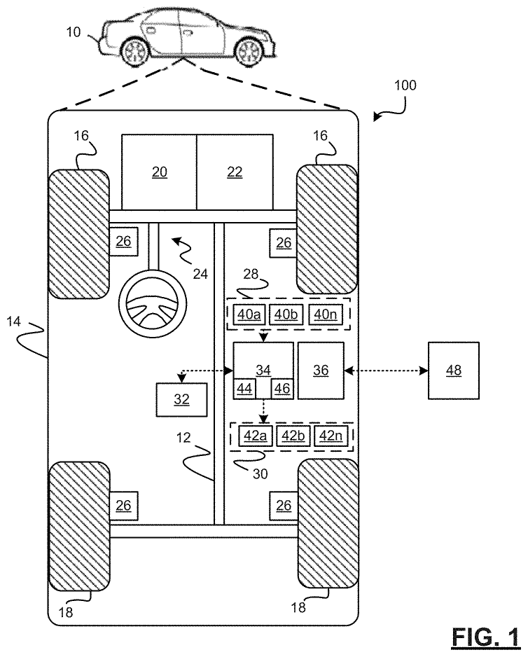

With reference to FIG. 1, a quality and safety assessing system shown generally at 100 is associated with a vehicle 10 in accordance with various embodiments. As will be discussed in more detail below, the quality and safety assessing system 100 continuously monitors the vehicle 10 while in motion through a host of in-vehicle information sources (e.g., sensors, communication bus, etc.) and computes comprehensive scores and explanations about the safety and driving quality of an operator, either assisted partly or fully by autonomous driving features.

In various embodiments, the quality and safety assessing system 100 provides contextual data for use by different stakeholders (e.g., end users, development and safety engineers, insurance providers, etc.). For example, the scores provided by the quality and safety assessing system 100 enable drivers or occupants to receive intuitive, continuous, comprehensive safety scores, and historical data guided safety augmented navigation of the vehicle 10. In another example, the scores provided by quality and safety assessing system 100 enable designers to perform root cause analysis, design fixes, perform regression testing, and deploy system updates. In another example, the scores provided by the quality and safety assessing system 100 enable safety experts to catalogue known safe/unsafe scenarios, discover unknown safe/unsafe scenarios, define safety rules, verify compliance, and generate reports. In still another example, the scores provided by the quality and safety assessing system 100 enable regulators to define federal/state motor vehicle safety standards and certify the autonomous driving systems. In another example, explanations provided by the quality and safety assessing system 100 enable personalized business model development by auto insurance companies using continuous and comprehensive driving quality assessment information.

As depicted in FIG. 1, the vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16-18 are each rotationally coupled to the chassis 12 near a respective corner of the body 14.

In various embodiments, the vehicle 10 is an autonomous vehicle and the quality and safety assessing system 100 is incorporated into the autonomous vehicle 10 (hereinafter referred to as the autonomous vehicle 10). The autonomous vehicle 10 is, for example, a vehicle that is automatically controlled to carry passengers from one location to another. The vehicle 10 is depicted in the illustrated embodiment as a passenger car, but it should be appreciated that any other vehicle including motorcycles, trucks, sport utility vehicles (SUVs), recreational vehicles (RVs), marine vessels, aircraft, etc., can also be used. In an exemplary embodiment, the autonomous vehicle 10 is autonomous in that it provides partial or full automated assistance to a driver operating the vehicle 10. As used herein the term operator is inclusive of a driver of the vehicle 10 and/or an autonomous driving system of the vehicle 10.

As shown, the autonomous vehicle 10 generally includes a propulsion system 20, a transmission system 22, a steering system 24, a brake system 26, a sensor system 28, an actuator system 30, at least one data storage device 32, at least one controller 34, and a communication system 36. The propulsion system 20 may, in various embodiments, include an internal combustion engine, an electric machine such as a traction motor, and/or a fuel cell propulsion system. The transmission system 22 is configured to transmit power from the propulsion system 20 to the vehicle wheels 16-18 according to selectable speed ratios. According to various embodiments, the transmission system 22 may include a step-ratio automatic transmission, a continuously-variable transmission, or other appropriate transmission. The brake system 26 is configured to provide braking torque to the vehicle wheels 16-18. The brake system 26 may, in various embodiments, include friction brakes, brake by wire, a regenerative braking system such as an electric machine, and/or other appropriate braking systems. The steering system 24 influences a position of the of the vehicle wheels 16-18. While depicted as including a steering wheel for illustrative purposes, in some embodiments contemplated within the scope of the present disclosure, the steering system 24 may not include a steering wheel.

The sensor system 28 includes one or more sensing devices 40a-40n that sense observable conditions of the exterior environment and/or the interior environment of the autonomous vehicle 10. The sensing devices 40a-40n can include, but are not limited to, radars, lidars, global positioning systems, optical cameras, thermal cameras, ultrasonic sensors, inertial measurement units, and/or other sensors.

The actuator system 30 includes one or more actuator devices 42a-42n that control one or more vehicle features such as, but not limited to, the propulsion system 20, the transmission system 22, the steering system 24, and the brake system 26. In various embodiments, the vehicle features can further include interior and/or exterior vehicle features such as, but are not limited to, doors, a trunk, and cabin features such as air, music, lighting, etc. (not numbered).

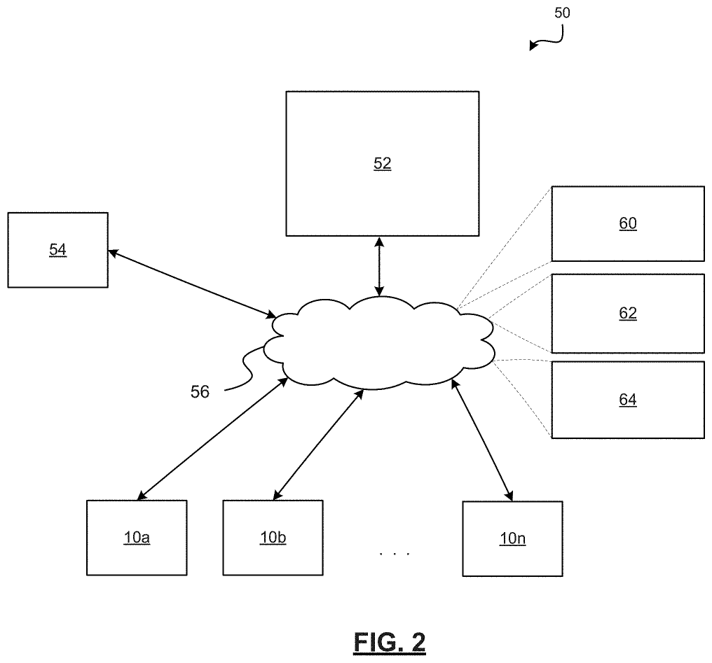

The communication system 36 is configured to wirelessly communicate information to and from other entities 48, such as but not limited to, other vehicles (“V2V” communication,) infrastructure (“V2I” communication), remote systems, and/or personal devices (described in more detail with regard to FIG. 2). In an exemplary embodiment, the communication system 36 is a wireless communication system configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

The data storage device 32 stores data for use in automatically controlling the autonomous vehicle 10. In various embodiments, the data storage device 32 stores defined maps of the navigable environment. In various embodiments, the defined maps may be predefined by and obtained from a remote system (described in further detail with regard to FIG. 2). For example, the defined maps may be assembled by the remote system and communicated to the autonomous vehicle 10 (wirelessly and/or in a wired manner) and stored in the data storage device 32. As can be appreciated, the data storage device 32 may be part of the controller 34, separate from the controller 34, or part of the controller 34 and part of a separate system.

The controller 34 includes at least one processor 44 and a computer readable storage device or media 46. The processor 44 can be any custom made or commercially available processor, a central processing unit (CPU), a graphics processing unit (GPU), an auxiliary processor among several processors associated with the controller 34, a semiconductor based microprocessor (in the form of a microchip or chip set), a macroprocessor, any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the autonomous vehicle 10.

The instructions may include one or more separate programs, each of which comprises an ordered listing of executable instructions for implementing logical functions. The instructions, when executed by the processor 44, receive and process signals from the sensor system 28, perform logic, calculations, methods and/or algorithms for automatically controlling the components of the autonomous vehicle 10, and generate control signals to the actuator system 30 to automatically control the components of the autonomous vehicle 10 based on the logic, calculations, methods, and/or algorithms. Although only one controller 34 is shown in FIG. 1, embodiments of the autonomous vehicle 10 can include any number of controllers 34 that communicate by communication messages over any suitable communication medium or a combination of communication mediums and that cooperate to process the sensor signals, perform logic, calculations, methods, and/or algorithms, and generate control signals to automatically control features of the autonomous vehicle 10.

In various embodiments, one or more instructions of the controller 34 are embodied in the quality and safety assessing system 100 and, when executed by the processor 44, process sensor data from the sensing devices 40a-40n, message data from the communication medium and/or communication system 36, and/or data sent to or received from the actuator devices 42a-42n, and compute scores and explanations about the safety and driving quality of the operator of the vehicle 10.

With reference now to FIG. 2, in various embodiments, the autonomous vehicle 10 described with regard to FIG. 1 may be suitable for use in the context of a taxi or shuttle system in a certain geographical area (e.g., a city, a school or business campus, a shopping center, an amusement park, an event center, or the like) or may simply be managed by a remote system. For example, the autonomous vehicle 10 may be associated with an autonomous vehicle based remote transportation system. FIG. 2 illustrates an exemplary embodiment of an operating environment shown generally at 50 that includes an autonomous vehicle based remote transportation system 52 that is associated with one or more autonomous vehicles 10a-10n as described with regard to FIG. 1. In various embodiments, the operating environment 50 further includes one or more user devices 54 that communicate with the autonomous vehicle 10 and/or the remote transportation system 52 via a communication network 56.

The communication network 56 supports communication as needed between devices, systems, and components supported by the operating environment 50 (e.g., via tangible communication links and/or wireless communication links). For example, the communication network 56 can include a wireless carrier system 60 such as a cellular telephone system that includes a plurality of cell towers (not shown), one or more mobile switching centers (MSCs) (not shown), as well as any other networking components required to connect the wireless carrier system 60 with a land communications system. Each cell tower includes sending and receiving antennas and a base station, with the base stations from different cell towers being connected to the MSC either directly or via intermediary equipment such as a base station controller. The wireless carrier system 60 can implement any suitable communications technology, including for example, digital technologies such as CDMA (e.g., CDMA2000), LTE (e.g., 4G LTE or 5G LTE), GSM/GPRS, or other current or emerging wireless technologies. Other cell tower/base station/MSC arrangements are possible and could be used with the wireless carrier system 60. For example, the base station and cell tower could be co-located at the same site or they could be remotely located from one another, each base station could be responsible for a single cell tower or a single base station could service various cell towers, or various base stations could be coupled to a single MSC, to name but a few of the possible arrangements.

Apart from including the wireless carrier system 60, a second wireless carrier system in the form of a satellite communication system 64 can be included to provide uni-directional or bi-directional communication with the autonomous vehicles 10a-10n. This can be done using one or more communication satellites (not shown) and an uplink transmitting station (not shown). Uni-directional communication can include, for example, satellite radio services, wherein programming content (news, music, etc.) is received by the transmitting station, packaged for upload, and then sent to the satellite, which broadcasts the programming to subscribers. Bi-directional communication can include, for example, satellite telephony services using the satellite to relay telephone communications between the vehicle 10 and the station. The satellite telephony can be utilized either in addition to or in lieu of the wireless carrier system 60.

A land communication system 62 may further be included that is a conventional land-based telecommunications network connected to one or more landline telephones and connects the wireless carrier system 60 to the remote transportation system 52. For example, the land communication system 62 may include a public switched telephone network (PSTN) such as that used to provide hardwired telephony, packet-switched data communications, and the Internet infrastructure. One or more segments of the land communication system 62 can be implemented through the use of a standard wired network, a fiber or other optical network, a cable network, power lines, other wireless networks such as wireless local area networks (WLANs), or networks providing broadband wireless access (BWA), or any combination thereof. Furthermore, the remote transportation system 52 need not be connected via the land communication system 62, but can include wireless telephony equipment so that it can communicate directly with a wireless network, such as the wireless carrier system 60.

Although only one user device 54 is shown in FIG. 2, embodiments of the operating environment 50 can support any number of user devices 54, including multiple user devices 54 owned, operated, or otherwise used by one person. Each user device 54 supported by the operating environment 50 may be implemented using any suitable hardware platform. In this regard, the user device 54 can be realized in any common form factor including, but not limited to: a desktop computer; a mobile computer (e.g., a tablet computer, a laptop computer, or a netbook computer); a smartphone; a video game device; a digital media player; a piece of home entertainment equipment; a digital camera or video camera; a wearable computing device (e.g., smart watch, smart glasses, smart clothing); or the like. Each user device 54 supported by the operating environment 50 is realized as a computer-implemented or computer-based device having the hardware, software, firmware, and/or processing logic needed to carry out the various techniques and methodologies described herein. For example, the user device 54 includes a microprocessor in the form of a programmable device that includes one or more instructions stored in an internal memory structure and applied to receive binary input to create binary output. In some embodiments, the user device 54 includes a GPS module capable of receiving GPS satellite signals and generating GPS coordinates based on those signals. In other embodiments, the user device 54 includes cellular communications functionality such that the device carries out voice and/or data communications over the communication network 56 using one or more cellular communications protocols, as are discussed herein. In various embodiments, the user device 54 includes a visual display, such as a touch-screen graphical display, or other display.

The remote transportation system 52 includes one or more backend server systems, which may be cloud-based, network-based, or resident at the particular campus or geographical location serviced by the remote transportation system 52. The remote transportation system 52 can be manned by a live advisor, or an automated advisor, or a combination of both. The remote transportation system 52 can communicate with the user devices 54 and the autonomous vehicles 10a-10n to schedule rides, dispatch autonomous vehicles 10a-10n, and the like. In various embodiments, the remote transportation system 52 stores account information such as subscriber authentication information, vehicle identifiers, profile records, behavioral patterns, and other pertinent subscriber information.

In accordance with a typical use case workflow, a registered user of the remote transportation system 52 can create a ride request via the user device 54. The ride request will typically indicate the passenger's desired pickup location (or current GPS location), the desired destination location (which may identify a predefined vehicle stop and/or a user-specified passenger destination), and a pickup time. The remote transportation system 52 receives the ride request, processes the request, and dispatches a selected one of the autonomous vehicles 10a-10n (when and if one is available) to pick up the passenger at the designated pickup location and at the appropriate time. The remote transportation system 52 can also generate and send a suitably configured confirmation message or notification to the user device 54, to let the passenger know that a vehicle is on the way.

As can be appreciated, the subject matter disclosed herein provides certain enhanced features and functionality to what may be considered as a standard or baseline autonomous vehicle 10 and/or an autonomous vehicle based remote transportation system 52. To this end, an autonomous vehicle and autonomous vehicle based remote transportation system can be modified, enhanced, or otherwise supplemented to provide the additional features described in more detail below.

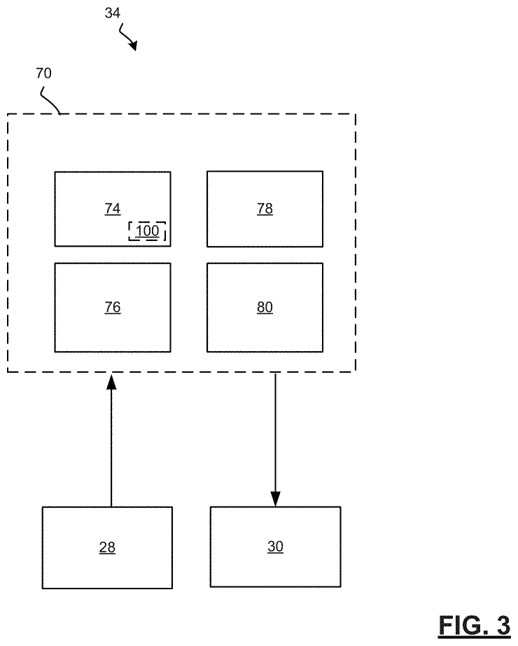

In accordance with various embodiments, the controller 34 implements an autonomous driving system (ADS) 70 to fully or partially operate the vehicle 10 as shown in FIG. 3. That is, suitable software and/or hardware components of the controller 34 (e.g., the processor 44 and the computer-readable storage device 46) are utilized to provide an autonomous driving system 70 that is used in conjunction with vehicle 10.

In various embodiments, the instructions of the autonomous driving system 70 may be organized by function, module, or system. For example, as shown in FIG. 3, the autonomous driving system 70 can include a computer vision system 74, a positioning system 76, a guidance system 78, and a vehicle control system 80. As can be appreciated, in various embodiments, the instructions may be organized into any number of systems (e.g., combined, further partitioned, etc.) as the disclosure is not limited to the present examples.

In various embodiments, the computer vision system 74 synthesizes and processes sensor data and predicts the presence, location, classification, and/or path of objects and features of the environment of the vehicle 10. In various embodiments, the computer vision system 74 can incorporate information from the multiple sensors of the sensor system 28, including but not limited to cameras, lidars, radars, and/or any number of other types of sensors.

The positioning system 76 processes sensor data along with other data to determine a position (e.g., a local position relative to a map, an exact position relative to lane of a road, vehicle heading, velocity, etc.) of the vehicle 10 relative to the environment. The guidance system 78 processes sensor data along with other data to determine a path for the vehicle 10 to follow. The vehicle control system 80 generates control signals for controlling the vehicle 10 according to the determined path.

In various embodiments, the controller 34 implements machine learning techniques to assist the functionality of the controller 34, such as feature detection/classification, obstruction mitigation, route traversal, mapping, sensor integration, ground-truth determination, and the like.

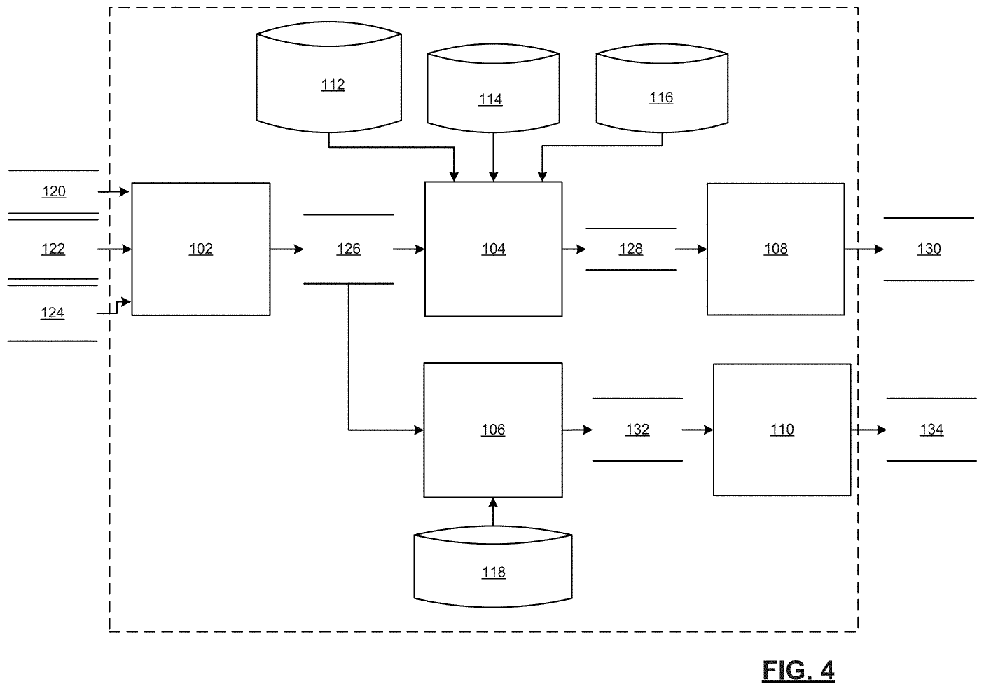

As mentioned briefly above, parts of the quality and safety assessing system 100 of FIG. 1 are included within the ADS 70, for example, as a separate system 82 (as shown) or incorporated into one or more of the other systems 74-80. For example, as shown in more detail with regard to FIG. 4 and with continued reference to FIGS. 1-3, the quality and safety assessing system 100 includes a causal analyzer module 102, a score determination module 104, an explanation determination module 106, a score presentation module 108, and an explanation presentation module 110. In various embodiments, the quality and safety assessing system 100 further includes one or more datastores that store models, rule sets, and/or parameter data for assessing the quality and safety of operation of the vehicle 10. In various embodiments, the datastores include a safe behavior model datastore 112, a scenario datastore 114, a rules datastore 116, and an explanation model datastore 118.

As can be appreciated, various embodiments of the system 100 according to the present disclosure can include any number of sub-modules and/or datastores. As can be appreciated, the sub-modules and datastores shown in FIG. 4 can be combined and/or further partitioned to similarly monitor the vehicle, computes scores, and provide explanations to stakeholders.

In various embodiments the causal analyzer module 102 receives sensor data 120, message data 122, and actuator data 124. The sensor data 120 includes data generated by one or more sensing devices of the sensor system 28. The message data 122 includes data generated from messages communicated on the communication medium and/or by the communication system 36. The actuator data 124 includes data generated as a result of controlling one or more actuators of the actuator system 30 (e.g., actuation commands, actuator statuses, etc.).

The causal analyzer module 102 analyzes the received data 120-124 to determine a causal time series of events within a time period and generate time series data 126 based thereon. For example, the causal analyzer module 102 extracts the context of a scenario from the sensor data 120 and the message data 122. The context can include, for example, road features, objects, object types, locations, etc. The causal analyzer module 102 then analyzes the context with the actuator data 124 to determine causes of behavior in the scenario and generates a casual time series of events.

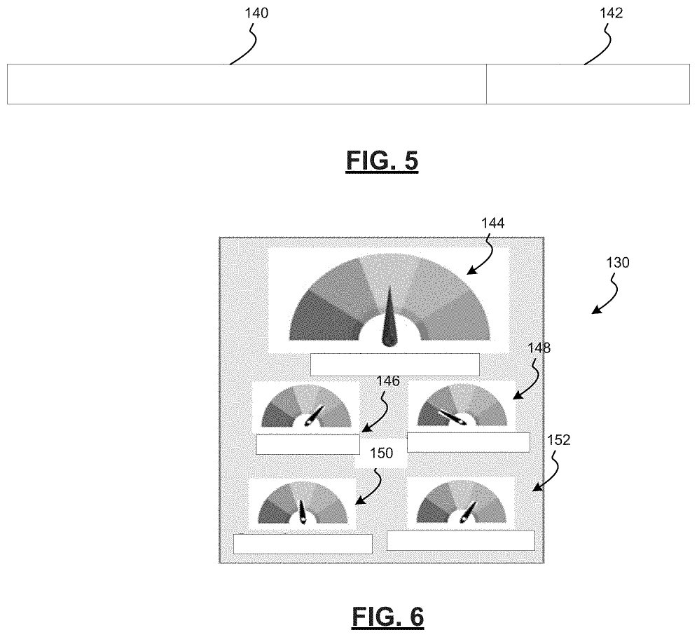

For example, the causal time series can include a listing of actors (e.g., vehicle A, Vehicle B, semi-truck C, traffic signal, etc.), a location of each actor, and an action/status of each actor for time (t) of a scenario (t1-t6). In various embodiments, as shown in FIG. 5, the data can be represented as binary values, enumerations, floats, etc. and assembled in vector form where context vector information 140 is assembled and concatenated with assembled driving behavior vector information 142.

With reference back to FIG. 4, in various embodiments, the score determination module 104 receives the time series data 126. The score determination module 104 evaluates the time series data 126 with one or more rule sets or models to determine one or more scores associated with safety and quality of the scenario. In various embodiments, the score determination module 104 processes the time series data 126 with a rule set defining traffic rules and stored in the rules datastore 116 to determine whether the actors in the scenario are operating according to defined traffic rules associated with the scenario. The score determination module 104 generates a safety score based on a number of rules that complied with in the scenario.

In various embodiments, the score determination module 104 processes the time series data 126 with scenario data indicating known safe/unsafe scenarios and stored in the scenario datastore 114. The score determination module 104 generates and/or updates the safety score based on whether the scenario matches known safe/unsafe scenarios. In various embodiments, when the time series data 126 does not match with a labeled scenario, the time series data 126 is an uncovered unknown scenario and can be sent to an expert for evaluation and labeling of safe/unsafe.

In various embodiments, the score determination module 104 processes the time series data 126 with a baseline safety and behavior model stored in the safe behavior model datastore 112. In various embodiments, the baseline safety and behavior model is a machine learning model implemented as one or more convolutional neural networks, or one or more gradient boosting machines. As can be appreciated, other machine learning models can be implemented, in various embodiments.

In various embodiments, the safety and behavior model provides quantitative values for safety and behavior attributes such as stability, informativeness, cautiousness, attentiveness, etc. These quantitative values are then used to compute an overall quality score. For example, in various embodiments, the overall quality score is computed as:

$${L}_{Driving Quality} = ‖ {F}_{stability} ( X ) - {Y}_{stability} ‖ + α \cdot ‖ {F}_{informative} ( X ) - {Y}_{informative} ‖ + β \cdot ‖ {F}_{cautiousness} ( X ) - {Y}_{cautiousness} ‖ + γ \cdot ‖ {F}_{attentiveness} ( X ) - {Y}_{attentiveness} ‖ .$$

Where α, β and γ represent a set of weighting parameters for each safety and behavior attributes, respectively, in the machine learning process. ∥·∥ represents an objective function that measures the distance between ground-truth values from the training data and the corresponding predicted values from a machine learning model. Objective functions are minimized in a machine learning process. As can be appreciated, other objective functions as well as combination of those can be implemented, in various embodiments. In various embodiments, the machine learning models are trained based on ground truth data and crowd sourced data from other vehicles.

In various embodiments, the score presentation module 108 receives the score data 128. The score presentation module 108 generates score display data 130 to present the scores in a textual format and/or a graphical format to an end user. For example, as shown in FIG. 6, the score display data 130 causes an arrow or needle of a graphical meter to move to a position that represents the computed score. In various embodiments, the meters can include a driving quality meter 144, a stability score 146, an informative score 148, a cautiousness meter 150, and an attentiveness meter 152. As can be appreciated, the scores can be presented in other forms and are not limited to the present example.

With reference back to FIG. 4, the explanation determination module 106 receives the time series data 126. The explanation determination module 106 processes the time series data 126 with one or more machine learning models such as, but not limited to, a trained classification network or trained a structured causal model (SCM). In various embodiments, the classification network inputs the time series causal event data and outputs probabilities of score classes indicative of the quality/rule conformance/safety. The resulting explanations can be defined key phrases providing feedback to respective stake holders (e.g., uncontrollable sudden brake, poor quality road rule conformance due to poor lighting, bad weather, etc.). In various embodiments, the structured causal model formulates explanations from identified causal relationships.

The explanation presentation module 110 receives the explanation data 132. The explanation presentation module 110 generates explanation display data 134 to present the explanations in a textual and/or graphical format to an end user.

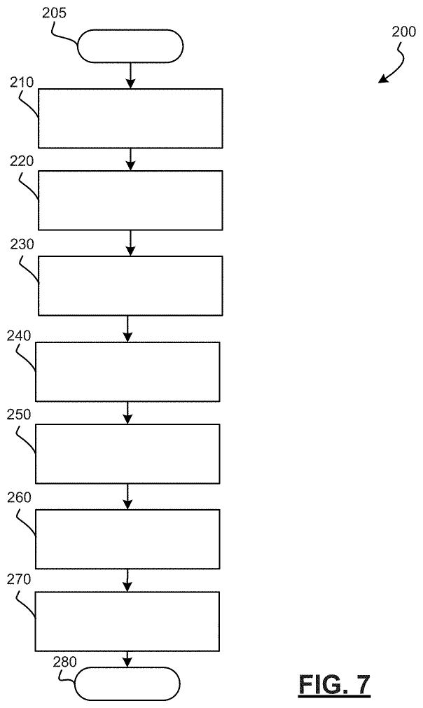

Referring now to FIG. 7, and with continued reference to FIGS. 1-4, a flowchart illustrates a control method 200 that can be performed by the system 100 of FIGS. 1 and 3 in accordance with the present disclosure. As can be appreciated in light of the disclosure, the order of operation within the method is not limited to the sequential execution as illustrated in FIG. 7 but may be performed in one or more varying orders as applicable and in accordance with the present disclosure. In various embodiments, the method 200 can be scheduled to run based on one or more predetermined events, and/or can run continuously during operation of the autonomous vehicle 10.

In one example, the method may begin at 205. The sensor data 120, message data 122, and actuator data 124 are received over a time period at 210. The sensor data 120 and the message data 122 are analyzed to determine the context of the scenario in the time period at 220. The actuator data 124 is analyzed with the context data to determine behavior within the time period at 230. The context data and the behavior data are assembled, for example, in vector format to form a time-series causal event chain at 240.

Thereafter, at 250, safety and quality scores are computed by processing the time series causal event chain with a safety and behavior rules and/or models, for example, as discussed above at 260. Thereafter, the causal explanations are determined, for example, based on explanation models as discussed above at 260. The resulting data including the time-series causal event chain, the computed scores, and/or the explanations are presented to the various end users by generating display data at 270. Thereafter, the method may end at 280.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method of monitoring an operator of a vehicle, comprising:
receiving, by a processor, data generated by the vehicle;
determining, by the processor, causal time series event data based on the received data;
computing, by the processor, a score for at least one of safety and quality based on a first machine learning model and the causal time series event data;
computing, by the processor, at least one explanation for the score based on a second machine learning model; and
generating, by the processor, display data to display at least one of the causal time series event data, the score, and the at least one explanation to an end user.

2. The method of claim 1, wherein the first machine learning model is a deep neural network.

3. The method of claim 2, wherein the deep neural network is trained based on ground truth data and crowd sourced driving data.

4. The method of claim 1, wherein the first machine learning model is a gradient boosting machine.

5. The method of claim 4, wherein the gradient boosting machine is trained based on ground truth data and crowd sourced driving data.

6. The method of claim 1, wherein the second machine learning model is a classification network that outputs probabilities of score, classes, and explanations.

7. The method of claim 1, wherein the second machine learning model is a structured causal model that outputs causal explanations.

8. The method of claim 1, wherein the received data comprises sensor data and message data, wherein the determining the causal time series event data comprises processing the sensor data and the message data over a time period to determine a context of a scenario associated with the time period, wherein the causal time series event data includes the context.

9. The method of claim 8, wherein the received data comprises actuator data, wherein the determining the causal time series event data comprises processing the actuator data over the time period to determine behavior of actors in the scenario, and wherein the causal time series event data includes the behavior.

10. The method of claim 9, wherein the causal time series event data includes a vector representation of the context concatenated with a vector representation of the behavior.

11. A system for monitoring an operator of a vehicle, comprising:
a first non-transitory computer module that, by a processor, receives data generated by the vehicle, and determines causal time series event data based on the received data;
a second non-transitory module that, by a processor, computes a score for at least one of safety and quality based on a first machine learning model and the causal time series event data;
a third non-transitory module that, by a processor, computes at least one explanation for the score based on a second machine learning model; and
a fourth non-transitory module that, by a processor, generates display data to display at least one of the causal time series event data, the score, and the at least one explanation to an end user.

12. The system of claim 11, wherein the first machine learning model is a deep neural network.

13. The system of claim 12, wherein the deep neural network is trained based on ground truth data and crowd sourced driving data.

14. The system of claim 11, wherein the first machine learning model is a gradient boosting machine.

15. The system of claim 14, wherein the gradient boosting machine is trained based on ground truth data and crowd sourced driving data.

16. The system of claim 11, wherein the second machine learning model is a classification network that outputs probabilities of score, classes and explanations.

17. The system of claim 11, wherein the second machine learning model is a structured causal model that outputs causal explanations.

18. The system of claim 11, wherein the received data comprises sensor data and message data, wherein the first non-transitory module determines the causal time series event data by processing the sensor data and the message data over a time period to determine a context of a scenario associated with the time period, wherein the causal time series event data includes the context.

19. The system of claim 18, wherein the received data comprises actuator data, wherein the first non-transitory module determines the causal time series event data by processing the actuator data over the time period to determine behavior of actors in the scenario, and wherein the causal time series event data includes the behavior.

20. The system of claim 19, wherein the causal time event series data includes a vector representation of the context concatenated with a vector representation of the behavior.
